(19) United States
(12) Patent Application Publication
(10) Pub. No.: US 2012/0026914 A1
(43) Pub. Date: Feb. 2, 2012

(54) Analyzing Network Activity by Presenting Topology Information with Application Traffic Quantity

(76) Inventors: Swapnesh Banerjee, Bangalore (IN); Srikanth Natarajan, Fort Collins, CO (US)

(21) Appl. No.: 12/882,239

(22) Filed: Sep. 15, 2010

(30) Foreign Application Priority Data
Jul. 28, 2010 (IN) 2145/CHE/2010

(51) Int. Cl. H04L 12/26

(52) U.S. Cl. 370/253

(57) ABSTRACT

A system for analyzing activity in a network collects, from one or more network components, flow information about traffic in the network. It associates the flow information with one or more application types. It enriches the flow information with topology information about the network. It then presents a report. The report identifies a quantity of traffic flowing into or out of a first network component as traffic corresponding to one application type, and also identifies a second network component to or from which the traffic is being sent.

### RELATED APPLICATIONS

Benefit is claimed under 35 U.S.C. 119(a)-(d) to Foreign application Serial No. 2145/CHE/2010 entitled “Analyzing Network Activity by Presenting Topology Information with Application Traffic Quantity” by Hewlett-Packard Development Company, L.P., filed on 28 Jul., 2010, in INDIA which is herein incorporated in its entirety by reference for all purposes.

### BACKGROUND

It is often necessary to analyze activity within a network, such as a data or communications network, in order to assess the network's effectiveness and utilization. Such activity analysis is also helpful when troubleshooting problems that may appear in the network from time to time. Numerous different kinds of computer applications and services may use resources within the network. Thus it would also be useful to be able to understand which application traffic is flowing in which parts of the network.

### BRIEF DESCRIPTION OF THE DRAWINGS

FIG. 1 is a flow diagram illustrating a method for analyzing network activity according to a general class of embodiments.

FIG. 2 is a block diagram illustrating an example flow packet that may be utilized by some embodiments.

FIG. 3 is a picture illustrating an example class of topology maps that may be produced by some embodiments.

FIG. 4 is a picture illustrating another example class of topology maps that may be produced by some embodiments.

FIG. 5 is a flow diagram illustrating an example method for producing a topology map such as the one shown in FIG. 4.

FIG. 6 is a flow diagram illustrating an example method for associating a traffic flow with an application type in accordance with some embodiments.

FIG. 7 generically illustrates example association mapping rules that may be utilized by some embodiments.

FIG. 8 is a block diagram illustrating a system for analyzing network activity in accordance with a general class of embodiments.

FIG. 9 is a flow diagram illustrating example behavior of the system of FIG. 8 in accordance with some embodiments.

FIG. 10 is a block diagram illustrating processors and computer-readable storage media in accordance with some embodiments.

### DETAILED DESCRIPTION

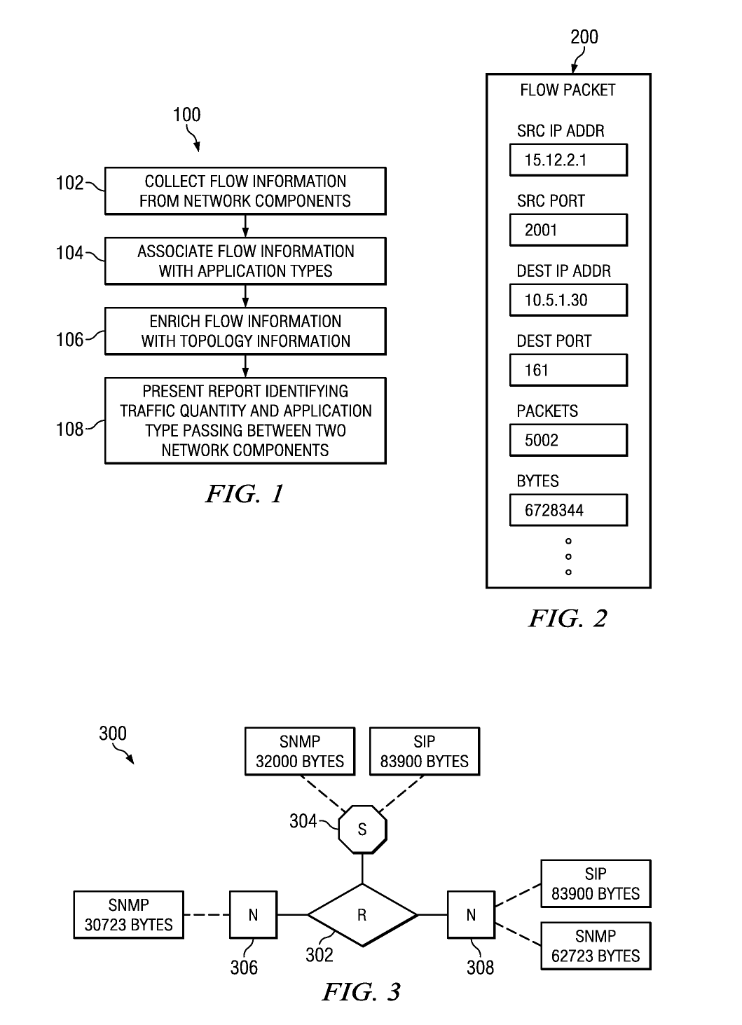

FIG. 1 illustrates a computer implemented method 100 for analyzing activity in a network. In step 102 of method 100, flow information about network traffic is collected using one or more components in the network that are capable of exporting flow information. One example of such a network component is a router that can be configured to export flow packets such as flow packet 200 illustrated in FIG. 2. Conventional routers may be configured to export the kind of information illustrated by flow packet 200 as well as other kinds of information. In the example of flow packet 200, the router is configured to sample network traffic passing through it over a time interval and to produce summary reports of traffic observed during the time interval. Flow packet 200 constitutes such a summary report. It summarizes all network packets that passed through the router during the time interval whose source internet protocol (“IP”) address was 15.12.2.1, whose source port was 2001, whose destination IP address was 10.5.1.30 and whose destination port was 161. In this example, the latter four attributes characterize one traffic flow. As flow packet 200 shows, there were 5002 network packets having these attributes during the time interval, and their total size was 6,728,344 bytes. The time interval for summarization may be configurable, but typically might be on the order of milliseconds in length.

In step 104 of method 100, the flow information collected is associated with one or more application types. As used herein, the term “application types” can mean any computer application or service that sends or receives network packets to accomplish its function. Typically these correspond to entities that are associated with the application layer of a network protocol stack. While IP is associated with the internetworking layer of a protocol stack, and the transmission control protocol (“TCP”) is associated with the transport layer of a protocol stack, services that use protocols like the simple network management protocol (“SNMP”) or the session initiation protocol (“SIP”) are application-layer entities. This is so because the protocols they use to accomplish their functions—SNMP or SIP in this example—are application layer protocols. The application layer of a network protocol stack is typically considered to be above the transport layer because transport layer packets encapsulate application layer packets.

In step 106 of method 100, the flow information is enriched with topology information about the network. The term “topology information” as used herein means information that describes components in the network and the connectivity between those components. The term “network components” may include any type of device that participates in or observes network traffic, including without limitation switches, routers, bridges and end nodes such as computers hosting application level processes. Topology information could include entries recording the fact that a switch and a router exist in the network, that the switch has eight interfaces, that the router has four interfaces, that the first interface of the switch is connected to the third interface of the router, and so on. One way to accomplish the enrichment step of step 106 is to associate the flow information from each flow exporting device in the network with topology information about that device. The linking data for making this association, as well as the flow information and the topology information itself, may be stored for example in a database.

In step 108 of method 100, a report is generated. The report may identify a quantity of traffic flowing into or out of a first network component as corresponding to a certain application type. The application type might be identified in a variety of ways. For example, it might be identified with the application level protocol that it uses (e.g. SNMP or SIP or some other application-level protocol), or it might be identified with a name (e.g. the payroll application or the employee directory lookup application). The report may also identify a second network component and indicate that the application traffic flowing into or out of the first network component is flowing to or from the second network component. In this manner, the network administrator is given more context for analyzing network activity than prior art systems were able to give. The administrator is able to observe, from a single report, the traffic quantity corresponding to a certain application type flowing along a certain network path between two certain network components.

The quantity of traffic presented in the report may be determined from the flow information collected, and the identity of the second network component to which or from which the traffic flows may be determined from the topology information.

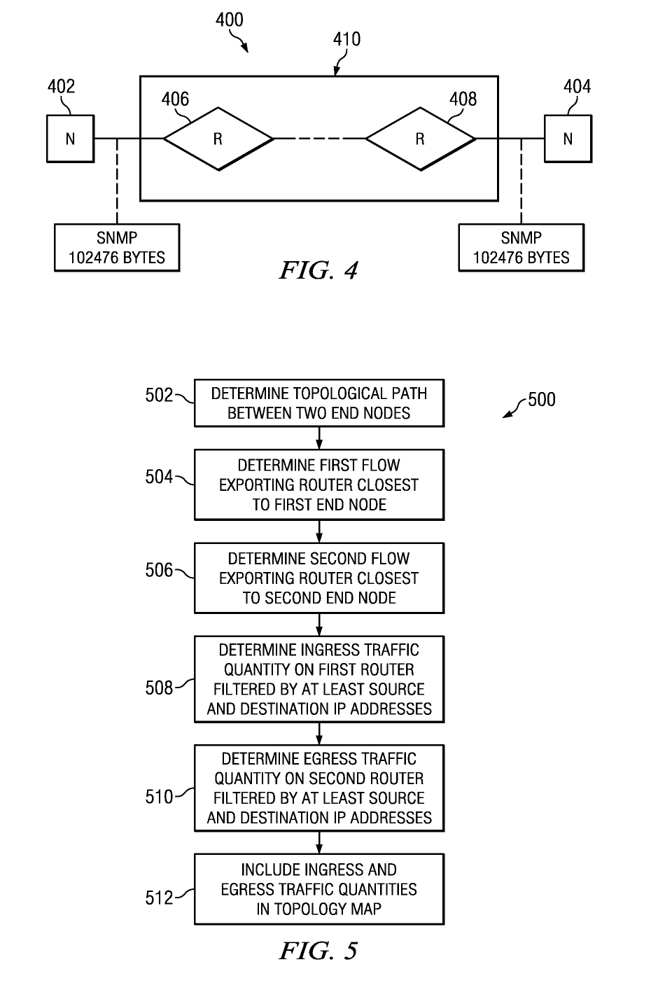

Various formats for the report are possible including tabular and textual formats. In one general class of embodiments, the report may be presented in the form of a topology map. Any suitable type of topology map may be presented, such as a graphical topology map on a computer display device. Two such types are illustrated in FIGS. 3 and 4 by way of example.

Topology map 300 in FIG. 3 displays traffic quantities by application type flowing into or out of router 302. Topology map 300 also includes representations of any network components that are immediately connected to router 302 and to or from which the application traffic is flowing. In the example, a switch 304 is connected to one interface of router 302, and end nodes 306, 308 are connected to other interfaces of router 302. Although directional arrows are not shown in the figure, it is possible to include directional arrows in the displayed topology map in relation to reported traffic quantities, based on whether the reported traffic quantity flows into our out of router 302. Alternatively, ingress and egress traffic over a link may be combined and reported as a total, as shown. In the example we see that 30,723 bytes of SNMP application traffic have passed between router 302 and end node 306 during the reported time interval. Similarly, 32,000 bytes of SNMP application traffic have passed between router 302 and switch 304, while 62,723 bytes of SNMP traffic have passed between router 302 and end node 308. In addition, 83,900 bytes of SIP traffic have passed between switch 304 and router 302, and also between router 302 and end node 308.

Topology map 400 in FIG. 4 displays two end nodes 402, 404 between which application traffic passes. Two routers 406, 408 are disposed between the two end nodes and on a topological path 410 taken by the traffic. In the example, it is apparent that 102,476 bytes of SIP traffic have passed between router 406 and end node 402, and that the same number of bytes have passed between router 408 and end node 404 during the relevant time period. This suggests that no packet loss is occurring along path 410.

A variety of techniques exist to produce results like the one shown in FIG. 4. An exemplary class of such techniques is illustrated by method 500 shown in FIG. 5. First, two end nodes of interest such as end nodes 402 and 404 in FIG. 4 are specified. Then in step 502, a topological path 410 may be determined between end nodes 402, 404. This may be done by querying previously discovered and stored information about the topology of the relevant network. From the determined topological path, in step 504 a flow exporting router 406 closest to end node 402 is determined. In step 506, a flow exporting router 408 closes to end node 404 is determined. Steps 504 and 506 may also be accomplished by querying the previously stored topological information about the network. In step 508, the collected flow information may be used to determine an ingress traffic quantity on one of routers 406, 408 and (in step 510) an egress quantity on the other of the two routers. The ingress and egress traffic quantities may be filtered by at least matching the source and destination IP addresses of the relevant packets with the IP addresses of end nodes 402 and 404. In step 512, the ingress and egress traffic quantities so determined are included in the topology map 400.

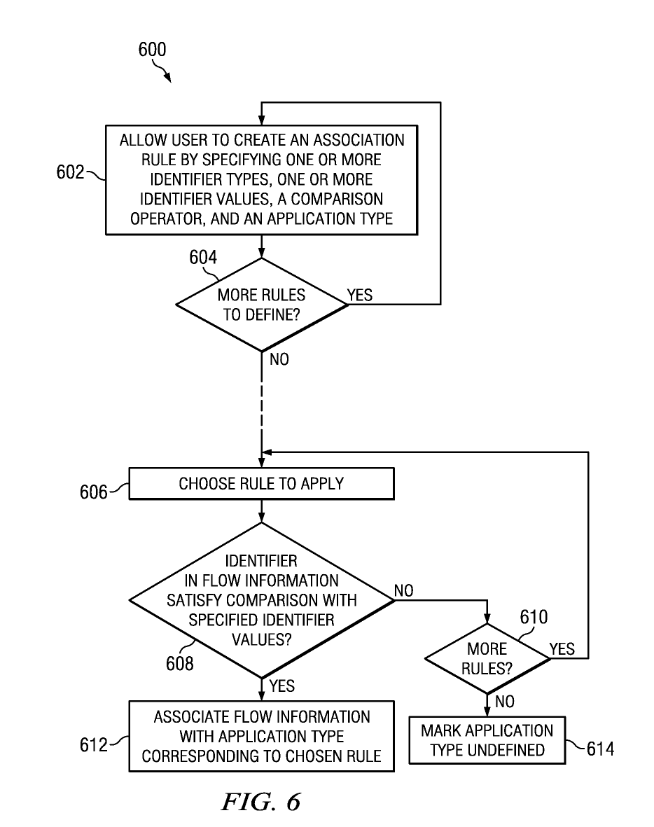

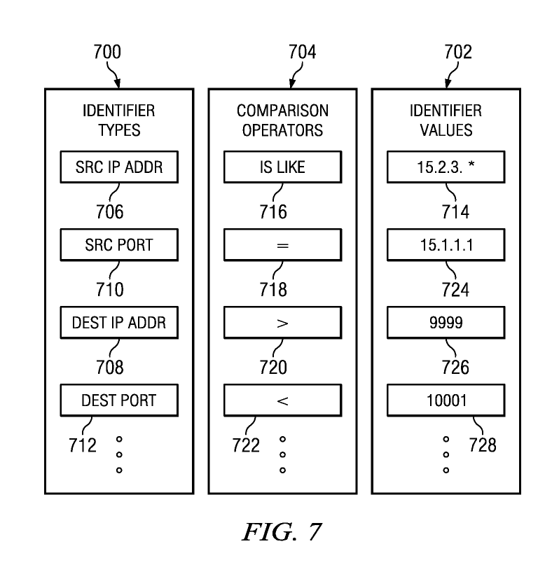

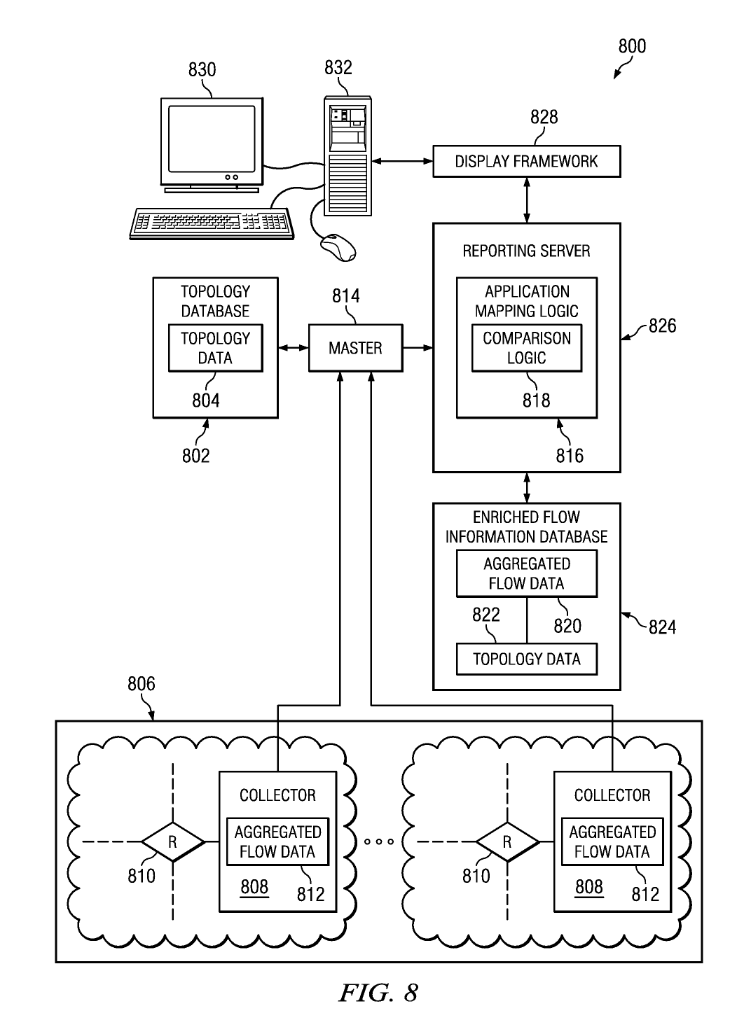

Step 104 of method 100, wherein the collected flow information is associated with one or more application types, may be accomplished in a variety of ways as well. In one general class of embodiments, the associating step may be done in a very flexible way in accordance with method 600 of FIG. 6, and as further illustrated by the examples of FIGS. 7-8. In steps 602-604 of method 600, a user interface may be presented that enables a user to define one or more association rules for mapping flow information to application types. Each such rule may include one or more identifier types 700, one or more identifier values 702, a comparison operator 704, and an application type to which a traffic flow should be mapped if it matches the criteria defined by the rule. Typically, identifier types 700 will constitute attributes of a traffic flow such as source IP address 706, source port 708, destination IP address 710 and/or destination port 712. Other flow attributes may also be used. Identifier values 702 might be any value or set of values that could correspond to one of identifier types 700. For example, an identifier value 702 might be an IP address 724 or a simple integer as in port numbers 726, 728. Other values may be used as well, to correspond with whichever identifier types 700 are being used. Comparison operators 704 may include, without limitation, an “is like” operator 716, an = operator 718, a > operator 720 and a < operator 722. Other operators may be used as well, such as >=, <= for example.

In one class of embodiments, a set of identifier values 702 may be specified in the form a regular expression such as regular expression 714. Regular expression 714, for example, specifies all IP addresses beginning with 15.2.3. An appropriate comparison operator 704 for use with regular expressions would be an “is like” operator 716. Thus, a rule might be defined such that a traffic flow should be mapped to application A if its source IP address is like 15.2.3.*. Any combination of identifier types 700, operators 704 and identifier values 702 may be employed to define a rule. Thus, another rule might be defined such that a traffic flow should be mapped to application B if its destination IP address is like 15.1.1.* and its destination port is >9999 and its destination port is <10001. Hierarchical groupings of rules may also be defined for more flexibility and ease of use. For example a set of conditions can be grouped to form a named expression. An application mapping can be based on a named expression. And a set of application mappings can form an application mapping group that may be applied to traffic flowing through a specified set of observation points in the network.

Once one or more application mapping rules have been defined, collected flow information may be associated with application types in accordance with steps 606-614. For a given traffic flow, each of the predefined rules may be applied until either the flow's characteristics are found to match the criteria of one of the rules or until all of the rules have been exhausted. Thus, in step 606, one of the rules may be chosen. If step 608 indicates that the applicable identifier type 700 for the given traffic flow corresponds with the applicable identifier value 702 according to the applicable comparison operator 704, then in step 612 the traffic flow is associated with the application type specified by the rule. If not, more rules may be tried as indicated at step 610. But if all rules have been exhausted and no match has been found for the given traffic flow, then the flow may be mapped to “unidentified application type” as indicated at step 614.

Numerous different kinds of computing platforms may be employed to create embodiments in accordance with the above behavioral descriptions. One general class of such embodiments is illustrated by way of example in FIG. 8, which shows a system 800 for analyzing activity in a network. System 800 may include a topology database 802 for containing topology data 804 that describes components of a network 806 and connectivity between the components. Multiple collector processes 808 may be configured to collect traffic flow data from multiple flow exporting components 810 of network 806. Collector processes 808 may also aggregate the traffic flow data to create aggregated flow data 812. For example, while flow exporting components 810 might generate flow packets 200 that correspond to millisecond sampling intervals, aggregated flow data 812 might represent an aggregate of the data taken from numerous flow packet sampling intervals—corresponding to an aggregate sampling interval perhaps on the order of seconds or minutes.

A master process 814 may be configured to receive aggregated flow data 812 sent by collector processes 808, to query topology database 802, and to associate topology data 804 with aggregated flow data 812. This association may be accomplished in a variety of ways. For example, for a given set of aggregated flow data 812, master process 814 may query topology database 802 to find all topology data relating to interfaces that exist on the flow exporting component 810 that produced the aggregated flow data. Associated flow information 820 and topology data 822 may be stored in an enriched flow information database 824 for later retrieval. Any convenient schema may be employed for this purpose depending on the nature of the data to be stored and the manner in which it is desired to retrieve it. A database purging process may be employed to prevent too much data from being accumulated at any given time.

Application mapping logic 816 may be configured to associate either raw flow data or aggregated flow data 812 with application types in accordance with the behavioral descriptions above. Comparison logic 818 may be used to do so. Although application mapping logic is shown in the drawing as being hosted by a reporting server 826, it may in fact be hosted elsewhere if desirable.

Finally, display framework 828 may be configured to present a report, such as the topology maps previously described, that identifies a quantity of traffic flowing into or out of one of the components in network 806, and that identifies an application type to which the traffic corresponds. It may do so by querying enriched flow information database 824. The report may be presented on a display device such as computer monitor 832 shown connected to a computing platform 832.

Any or all of the processes shown in system 800 may be distributed across numerous computing platforms if desirable. Moreover, collector processes 808 may be physically distributed in network 806 in order to improve performance and to reduce network bandwidth utilized by the collection of flow data.

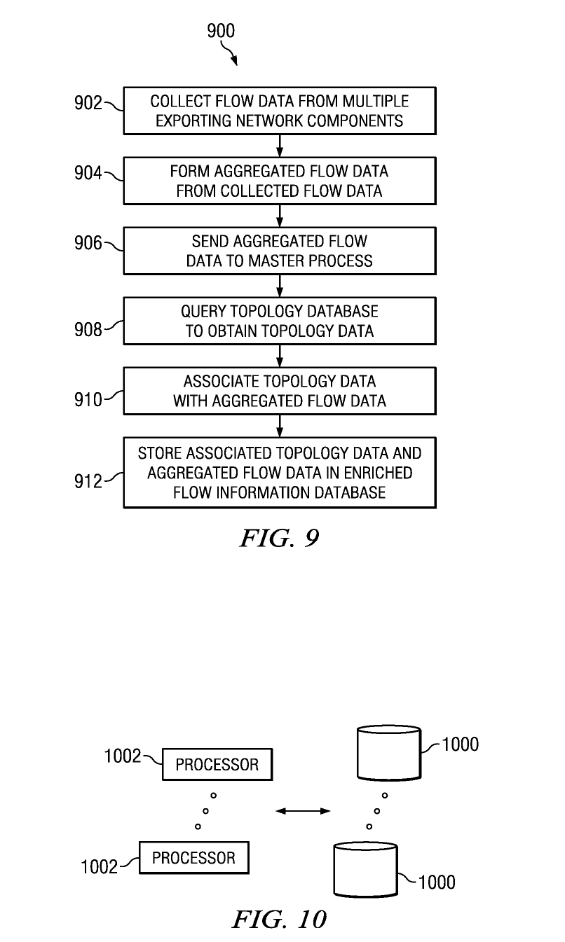

In summary, system 800 may operate generally in accordance with method 900 illustrated in FIG. 9. Namely, in step 902, system 800 collects flow data from multiple exporting network components 810. In step 904, it may form aggregated flow data 812 from the collected flow data. In step 906, the aggregated flow data 812 may be sent to master process 814. In step 908, master process 814 may query topology database 802 to obtain topology data 804 relevant to flow data 812. In step 910, topology data 804 and aggregated flow data 812 may be associated. In step 912, the associated topology data 822 and flow data 820 may be stored in enriched flow information database 824.

In yet another general class of embodiments, any or all of the above-described functionality may be stored as instructions on one or more tangible computer-readable storage media 1000 as shown in FIG. 10. The instructions may be such that, when executed by one or more processors 1002, the processors are caused to perform methods as described above. Storage media 1000 may take any conventional form including, without limitation, magnetic disks, optical media, flash memory, semiconductor read only memory and the like. Storage media 1000 may be located anywhere. For example, they may be local to processors 1002, or they may be located on a server that is accessible to processor 1002 such that the instructions can be downloaded via a network for later installation and/or execution locally.

While the invention has been described in detail with reference to certain embodiments thereof, the described embodiments have been presented by way of example and not by way of limitation. It will be understood by those skilled in the art and having reference to this specification that various changes may be made in the form and details of the described embodiments without deviating from the spirit and scope of the invention as defined by the appended claims.

What is claimed is:

1. A computer implemented method for analyzing activity in a network, comprising:
collecting, from one or more network components, flow information about traffic in the network;
associating the flow information with one or more application types;
enriching the flow information with topology information about the network; and
presenting a report that identifies a quantity of the traffic flowing into or out of a first network component as first traffic corresponding to one application type, and that identifies a second network component to or from which the first traffic is being sent.

2. The method of claim 1:
wherein the quantity of traffic is determined using the flow information and the identity of the second network component is determined using the topology information.

3. The method of claim 1:
wherein the report is presented graphically in the form of a topology map.

4. The method of claim 3:
wherein the topology map represents the first network component and any immediately connected network components to or from which the first traffic is being sent.

5. The method of claim 3:
wherein the topology map represents two end nodes between which the first traffic passes and at least two routers, between the two end nodes, through which the first traffic also passes.

6. The method of claim 5, further comprising:
determining a topological path between the two end nodes;
from the topological path, determining a first flow exporting router closest to one of the end nodes and a second flow exporting router closest to the other end node;
from the flow information, determining an ingress traffic quantity on the first router filtered by source and destination IP addresses corresponding to the two end nodes, and determining an egress traffic quantity on the second router filtered by the source and destination IP addresses corresponding to the two end nodes; and
including the ingress and egress traffic quantities in the topology map.

7. The method of claim 1:
wherein collecting flow information comprises using plural collecting processes to collect flow data exported by plural exporting devices and to aggregate the flow data collected, thereby creating aggregated flow data; and
wherein enriching the flow information comprises sending the aggregated flow data to a master process and using the master process to query a topology database to obtain topology data, to associate the topology data with the aggregated flow data, and to store the aggregated flow data and the associated topology data in an enriched flow information database.

8. The method of claim 7, wherein:
the plural collecting processes are physically distributed in the network.

9. The method of claim 1:
wherein associating the flow information with one or more application types comprises comparing at least one identifier in the flow information with a previously-defined set of identifiers specified in the form of a regular expression.

10. The method of claim 9:
wherein the at least one identifier comprises one of: a source IP address, a destination IP address, a source port, and a destination port.

11. The method of claim 1:
wherein associating the flow information with one or more application types comprises allowing a user to specify a value, to choose a comparison operator from a set of supported operators, and to choose an identifier type chosen from a set of supported identifier types; and
comparing at least one identifier in the flow information with the value using the chosen comparison operator;
wherein the set of supported operators includes at least =, > and <; and
wherein the set of supported identifier types includes at least source IP address, destination IP address, source port and destination port.

12. A system for analyzing activity in a network, comprising:
a topology database for containing information that describes components of the network and connectivity between the components;
plural collector processes configured to collect traffic flow data from plural flow exporting components of the network and to aggregate the flow data to create aggregated flow data;
a master process configured to receive the aggregated flow data from the plural collector processes, to query the topology database to receive topology data, and to associate the topology data with the aggregated flow data;
application mapping logic configured to associate either the flow data or the aggregated flow data with an application type; and
a display framework configured to present a topology map that identifies a quantity of traffic flowing into or out of at least a first one of the network components, and that identifies an application type to which the quantity of traffic corresponds.

13. The system of claim 12, wherein:
the topology map includes a representation of all network components that are immediately connected to the first network component and to or from which at least some of the quantity of traffic is being sent.

14. The system of claim 12, wherein the topology map comprises representations of:
two end nodes between which a first type of application traffic flows, and a path through which the first type of application traffic flows between the two end nodes;
a first flow exporting router located on the path and closest to one of the two end nodes;
a second flow exporting router located on the path and closest to the other of the two end nodes; and
an ingress quantity of the first type of application traffic for the first router and an egress quantity of the first type of application traffic for the second router.

15. The system of claim 12:
wherein the plural collector processes are physically distributed across plural computing devices in the network.

16. The system of claim 12, wherein the application mapping logic comprises:
comparison logic configured to compare at least one identifier in either the flow data or the aggregated flow data with a previously-defined set of identifiers specified by a regular expression.

17. The system of claim 16:
wherein the comparison logic is able to support at least the following types of identifiers: source IP address, destination IP address, source port, and destination port.

18. The system of claim 12, where the application mapping logic comprises:
comparison logic configured to compare at least one identifier in either the flow data or the aggregated flow data with a previously specified value, and to use any of the =, > and < operators to do so in accordance with a previously-specified one of those operators.

19. The system of claim 12:
wherein the comparison logic is able to support at least the following types of identifiers: source IP address, destination IP address, source port, and destination port.

20. At least one tangible computer-readable storage medium containing instructions that, when executed on at least one processor, cause the at least one processor to perform a method comprising:
collecting, from one or more flow exporting network components, flow information about traffic in the network;
associating the flow information with one or more application types;
querying a topology database, containing descriptions of components in the network and connectivity between them, to obtain topology information relating to the flow exporting components; and
presenting a topology map that identifies a quantity of the traffic flowing into or out of a first network component as first traffic corresponding to one application type, and that identifies a second network component to or from which the first traffic is being sent.
